(19) United States
(12) Patent Application Publication
(10) Pub. No.: US 2017/0168165 A1
(43) Pub. Date: Jun. 15, 2017

(54) SCINTILLATION DEVICE WITH MOISTURE BARRIER

(71) Applicant: SAINT-GOBAIN CERAMICS & PLASTICS, INC., Worcester, MA (US)

(72) Inventors: Michael R. KUSNER, Auburn Township, OH (US); Peter R. MENGE, Novelty, OH (US)

(21) Appl. No.: 15/380,343

(22) Filed: Dec. 15, 2016

Related U.S. Application Data
(60) Provisional application No. 62/267,765, filed on Dec. 15, 2015.

(51) Int. Cl. G01T 1/203; G01T 1/20

(52) U.S. Cl. CPC G01T 1/203; G01T 1/2018; G01N 2223/626

(57) ABSTRACT

A scintillation device can include a scintillator and a pliable moisture barrier encapsulating the scintillator. The moisture barrier can have a low vapor transmission rate and prevent significant water gain on or near the scintillator.

### CROSS-REFERENCE TO RELATED APPLICATION(S)

This application claims priority under 35 U.S.C. §119(e) to U.S. Patent Application No. 62/267,765 entitled “SCINTILLATION DEVICE WITH MOISTURE BARRIER,” by Michael R. Kusner and Peter R. Menge, filed Dec. 15, 2015, which is assigned to the current assignee hereof and incorporated herein by reference in its entirety.

### FIELD OF THE DISCLOSURE

The present disclosure relates to scintillation devices including moisture barriers with a low vapor transmission rate.

### BACKGROUND

Radiation detectors can include a scintillator, which is a material that can emit light upon capturing radiation or ionized particles. Exposing a scintillator to moisture can damage the sensitivity or useful life of the scintillator. A moisture barrier can permit use of the radiation detector in uncontrolled or outdoor environments. There exists a need for a scintillation device that provides an improved moisture barrier that is commercially feasible.

### BRIEF DESCRIPTION OF THE DRAWINGS

Embodiments are illustrated by way of example and are not limited in the accompanying figures.

FIG. 1 includes an illustration of a scintillation device according to embodiments described herein.

FIG. 2 includes an illustration of a radiation detector according to embodiments described herein.

FIG. 3 includes an illustration of a radiation detector in use according to embodiments described herein.

FIG. 4 includes a photograph of samples from the Example.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation detection arts.

Certain embodiments of this disclosure are directed to a scintillation device that can reduce the amount of moisture that reaches a scintillator. In an uncontrolled or outdoor environment, a scintillator, such as a plastic scintillator, can absorb water vapor from the air. When subsequently exposed to cold temperatures, the water vapor can condense within the scintillator. The condensation can disrupt the normal operation of the scintillator, such as scattering scintillation light and reducing radiation detection performance, such as the sensitivity and signal-to-noise detection of the scintillator. Rigid metal housings can be used to reduce water vapor permeation. However, such rigid metal housings are difficult to implement, particularly as the length of the scintillator becomes longer. A need exists for a more flexible moisture barrier that can enclose large or complex shapes.

As depicted in FIG. 1, a scintillation device 100 can include a scintillator 102 encapsulated by a moisture barrier 104. In certain embodiments, the moisture barrier 104 can be a pliable moisture barrier. As used herein, the term “pliable” refers to a material that is compliant and will readily conform to the general shape and contours of the scintillator.

In further embodiments, the moisture barrier 104 can reduce the passage of fluid, such as water vapor, or the water gain within the moisture barrier. For example, an interior of the moisture barrier 104 may have a water gain of no greater than 0.005%, no greater than 0.004%, or even no greater than 0.003%, based on a total volume of the interior of the moisture barrier, measured at room temperature following an exterior of the moisture barrier 104 being exposed to a 55° C. environment at 80% humidity for 400 hours. In other embodiments, the water gain can be at least 0.0001%, based on a total volume of the interior of the moisture barrier, measured at room temperature following an exterior of the moisture barrier 104 being exposed to a 55° C. environment at 80% humidity for 400 hours.

As discussed above, exposure to moisture can reduce the sensitivity and useful life of the scintillator 102. The moisture barrier 104 can assist in retaining the sensitivity of the scintillator 102. In certain embodiments, the scintillator 102 can retain at least 80%, at least 85%, or at least 90% of gamma ray sensitivity after an exterior of the moisture barrier 104 is exposed to a 55° C. environment at 80% humidity for 400 hours and then a −40° C. environment at 80% humidity for 36 hours. In other embodiments, the scintillator 102 may retain no greater than 99%% of gamma ray sensitivity after an exterior of the moisture barrier 104 is exposed to a 55° C. environment at 80% humidity for 400 hours and then a −40° C. environment at 80% humidity for 36 hours. In an embodiment, the scintillator can retain at least 80%, or at least 85%, or at least 90% of gamma ray sensitivity after an exterior of the moisture barrier is exposed to a 55° C. environment at 85% humidity for 1500 hours. In an embodiment, the scintillator can retain at most 100%, or at most 99%, or at most 97% of gamma ray sensitivity after an exterior of the moisture barrier is exposed to a 55° C. environment at 85% humidity for 1500 hours.

In an embodiment, after 1500 hours at 55° C. and 85% humidity, the device can exhibit a change in detectability of gamma rays at −30° C. of no greater than 5%, or no greater than 3%, or no greater than 1%. In an embodiment, after 1500 hours at 55° C. and 85% humidity, the device exhibits a change in detectability of gamma rays at −30° C. of at least 0%, or at least 0.01%, or at least 0.05%.

In an embodiment, after 1500 hours at 55° C. and 85% humidity, the device can exhibit a change in gamma ray pulse height ratio of no greater than 5%, or no greater than 3%, or no greater than 1%. In an embodiment, after 1500 hours at 55° C. and 85% humidity, the device exhibits a change in gamma ray pulse height ratio of at least 0%, or at least 0.01%, or at least 0.05%.

In particular embodiments using a transparent plastic scintillator as the scintillator 102, exposing the scintillator 102 to moisture can also reduce the transparency of the plastic. The moisture barrier can assist to reduce haze and retain significant visible light transmission properties of the scintillator 102. For example, the scintillator 102 can have a visible light transmission at least 65%, at least 70%, or at least 75% after an exterior of the moisture barrier 104 is exposed to a 55° C. environment at 80% humidity for 400 hours. In other embodiments, the scintillator 102 may have a visible light transmission no greater than 99%, no greater than 97%, or no greater than 95% after an exterior of the moisture barrier 104 is exposed to a 55° C. environment at 80% humidity for 400 hours The visible light transmission is measure according to ASTM D1003-13.

The moisture barrier can include at least one water-resistant layer that decreases the vapor transmission rate of the moisture barrier. The vapor transmission rate is measured according to ASTM E 96 or F 1249. In certain embodiments, the moisture barrier may have a vapor transmission rate of no greater than 5×10⁻¹¹ g/cm²/s, no greater than 3×10⁻¹¹ g/cm²/s, or even no greater than 1.1×10⁻¹¹ g/cm²/s. In further embodiments, the moisture barrier can have a vapor transmission rate of at least 1×10⁻¹⁵ g/cm²/s, at least 1×10⁻¹⁴ g/cm²/s, or even at least 1.1×10⁻¹³ g/cm²/s.

In certain embodiments, the water-resistant layer can include a metal. The metal can include an atomic metal, a metal alloy, a metal oxide, or any combination thereof. The metal can have a low atomic number. For example, the metal can include a metal having an atomic number of no greater than 34. In particular embodiments, the metal can include an aluminum, a copper, or a combination thereof. In further embodiments, the water-resistant layer can be a continuous layer, the continuous layer can include a foil, such as a metal foil. The continuous layer or metal foil can include the metal discussed above. The continuous layer can provide superior performance compared to a deposited or sprayed-on metal film.

In addition to the water-resistant layer, the moisture barrier can include at least one polymer layer, at least two polymer layers, at least three polymer layers, or at least four polymer layers. In certain embodiments, at least one of the polymer layers can include a thermoplastic polymer. The thermoplastic polymer can assist in forming a seal or a seam on the moisture barrier. In particular embodiments, the thermoplastic polymer can include a polyethylene, such as a liner low density polyethylene.

In further embodiments, at least one of the polymer layers can include a polyester. In particular embodiments, the polyester can include a semi-aromatic polyester. The semi-aromatic polyester can include, for example, a polyethylene terephthalate, a polybutylene terephthalate, a polytrimethylene terephthalate, a polyethylene naphthalate, or any combination thereof. In more particular embodiments, the at least one polymer layer including a polyester can form an outermost layer of the moisture barrier. In certain embodiments, the polymer layer comprising the polyester can be a protective layer and can contribute to the water-resistance of the moisture barrier.

The water-resistant layer can be disposed between polymer layers. For example, the moisture barrier can include at least one polymer layer on a first side of the water-resistant layer and at least one polymer layer on an opposite second side of the water-resistant layer. In more particular embodiments, the moisture barrier can include at least two polymer layers on a first side of the water-resistant layer and at least two polymer layers on an opposite second side of the water-resistant layer. In more particular embodiments, the at least two polymer layers on the first side of the water-resistant layer can include a first polymer layer comprising a first polymer and a second polymer layer comprising a second polymer that is different that the first polymer. Further, in particular embodiments, each of the at least two polymer layers on the second side of the water-resistant layer can include a third polymer layer comprising a third polymer and a fourth polymer layer comprising a fourth polymer that is different than the third polymer. In certain, the polymer layers nearest the water-resistant layer can assist in protecting the water-resistant properties of the water-resistant layer.

The scintillator 102 of the scintillation device 100 can include a scintillator material. The scintillator material can be sensitive to particular types of radiation, for example, gamma rays or neutrons, such that when the material is struck by a particular type of radiation or ionized particle, the scintillator responds by emitting a scintillating light at a particular wavelength. The scintillating light can be captured by a photosensor, such as a photomultiplier tube, a semi-conductor based photomultiplier, a hybrid photomultiplier, or the like, which converts the scintillating light to an electronic signal for processing. As such, a detector can provide a user with the ability to detect and record radiation events, which in the context of security inspection applications, can enable users to detect the presence of radioactive material.

In certain embodiments, the scintillator can include an inorganic scintillator material, an organic scintillator material, or any combination thereof. In particular embodiments, the scintillator can include a plastic scintillator material. The plastic scintillator material can include an organic scintillator material comprising 2,5-diphenyloxazole, 1,4-bis-2-(5-phenyloxazolyl)-benzene), terphenyl, 1,1,4,4-tetraphenylbutadiene, a tris complex of 2,6-pyridine dicarboxylic acid (dipicolinic acid, DPA), an Ir(mppy)3, an iridium-tris[2-(4-totyl)pyridinato-NC2], a pyrazolate-bridged cyclometalated platinum(II) complex, or any combination thereof. The inorganic scintillator material can include a NaI, a CsI, a SrI₂, a LiI, a LiF, a LaBr₃, a LaCl₃, a CeBr₃, a Cs₂LiLaBr₆, a Cs₂LiLaBr₆₋ₓClₓ, a Cs₂LiLaBr₆₋ₓIₓ, a Cs₂LiYCl₆, a Cs₂LiYCl₆₋ₓBrₓ, a CsSr₂I₅, a LiSr₂I₅, a BaF₂, or any combination thereof.

In certain embodiments, the scintillator can include a scintillator compound or a high atomic number compound dispersed in a plastic matrix. The high atomic number compound can include a non-scintillating compound. In particular embodiments, the high atomic number compound can include a Bi, a Pb, an Jr, a Pt, an Au, or any combination thereof. The plastic matrix can include a transparent polymer. The plastic matrix can include an epoxy, a polyvinyl toluene, a polystyrene, a polymethylmethacrylate, a polyvinylcarbazole, a polybutyrate, a polycarbonate, a polyurethane, a glycol modified polyethylene terphthalate, or any combination thereof.

The moisture barrier 104 can be used with scintillators 102 of various shapes and sizes, including large scintillators. For example, the scintillator 102 can have a volume of at least 0.25 m³, at least 0.27 m³, or even at least 0.29 m³. Further, the scintillator 102 can have a length in a longest dimension of at least 1 m, at least 1.2 m, at least 1.4 m, at least 1.6 m, or at least 1.8 m. In particular embodiments, the scintillator 102 can have a length in a longest dimension of at least 2 m. At these lengths, it can become particularly unwieldy to use a rigid metal container. In further embodiments, the length may be no greater than 10 m, no greater than 8 m, or no greater than 6 m.

The scintillator 102 can be contained within the moisture barrier 104. In certain embodiments, the scintillator 102 can be completely surrounded by the moisture barrier 104. In further embodiments, the moisture barrier 104 can be sealed around the scintillator 102. For example, the moisture barrier 104 can form a seal 106 with itself, such as a heat seal. In certain embodiments, the width of the seal 106 can contribute to barrier properties of the moisture barrier 104. For example, the barrier properties of the moisture barrier 104 can improve as the seal width increases. In particular embodiments, the seal 106 can have a width of at least 0.2 cm, at least 0.5 cm, at least 1 cm, at least 2 cm, or at least 3 cm. Although the seal 106 can have various lengths, in certain embodiments, the seal 106 may have a width of no greater than 30 cm, no greater than 20 cm, or no greater than 10 cm. The width refers to the distance across the seal in a direction orthogonal to the length of the seal and the thickness of the seal. The length of the seal refers to the longest dimension of the seal. The thickness refers to the dimension of the seal that extends through the seal from an exterior surface of the seal to an interior surface of the seal.

In certain embodiments, the moisture barrier 104 can include a seal 106 on at least one edge, at least two edges, or at least three edges of the moisture barrier 104. In particular embodiments, the moisture barrier 104 can be a bag having at least one edge include a fold instead of a seal, and the scintillator 102 can be placed in the bag. In other embodiments, the scintillator 102 can be wrapped with moisture barrier material and the moisture barrier material can be sealed around the scintillator 102 to form the moisture barrier 104.

In other embodiments, the moisture barrier 104 can be formed by wrapping the scintillator 102 with at least one sheet comprising the water-resistant layer and then coating the water-resistant layer with a polymer or ceramic coating material. The coating material can be applied to the scintillator 302 using a dip coating process, a brush coating process, a spray coating process, a chemical vapor deposition process, a physical vapor deposition process, or a process of dispersing and activating an expandable powder on the water-resistant layer. In certain embodiments, the water-resistant layer can be taped down after wrapping the scintillator 102 and prior to coating with the polymer or ceramic coating, particularly during a spray coating.

In certain embodiments, the scintillation device can further comprise a desiccant, or other moisture absorbing or adsorbing material, to assist in reducing the water interacting with the scintillator in the interior of the moisture barrier. In particular embodiments, the desiccant can be located within the moisture barrier.

In certain embodiments, the moisture barrier can be a fluid barrier that functions as a barrier to other fluids, including gases such as oxygen. In particular embodiments, the scintillator device can include an oxygen getter.

In another aspect, in order to maintain the sensitivity of the device in which the scintillator 102 having the moisture barrier 104 disposed there around is installed, the areal density of the material forming the moisture barrier 104 can be no greater than 0.1 g/cm², no greater than 0.05 g/cm², no greater than 0.04 g/cm², no greater than 0.03 g/cm², no greater than 0.02 g/cm², or even no greater than 0.015 g/cm². In further embodiments, the areal density can be at least 0.0005 g/cm², at least 0.001 g/cm², or at least 0.005 g/cm².

In certain embodiments, the moisture barrier 104 can include a substantially uniform thickness over the scintillator 102. The thickness can be at least about 0.1 mm. Further, the thickness can be at least about 0.25 mm, such as 0.5 mm, 1.0 mm, 2.0 mm, 3.0 mm, 4.0 mm, or 5.0 mm. However, increasing the thickness too much can potentially interfere with the sensitivity of the scintillator. In certain embodiments, the thickness may be no greater than about 10 mm.

The visible light transmission of the moisture barrier 102 can be affected by the material of the water-resistant layer. In certain embodiments, the water-resistant layer can have a high visible light transmission, whereas, in other embodiments, the water-resistant layer can have a low visible light transmission. In particular embodiments, the water-resistant layer can have a visible light transmission of no greater than 30%, no greater than 25%, no greater than 20%, or even no greater than 15%. The visible light transmission is measured according to ASTM D1003-13. In certain instances, the moisture barrier 104 can include a window portion that can permit the transmission of light as necessary for the scintillator to operate properly. The scintillation device can further include a grounding wire coupled to the moisture barrier.

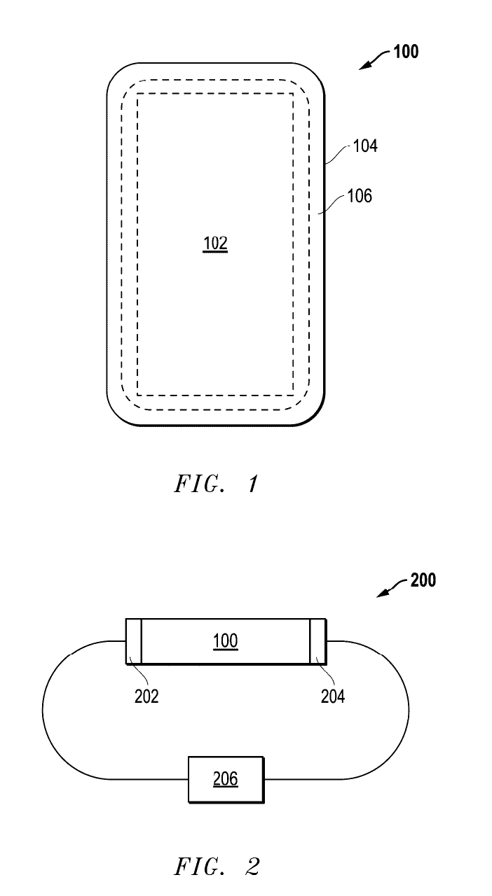

Further, as illustrated in FIG. 2, the scintillation device 100 can be installed within a radiation detection device 200. The radiation detection device can include a medical imaging apparatus, a well logging apparatus, a security inspection apparatus (e.g. a port-of-entry detector), a handheld radiation probe, or the like. The radiation detection device can include the scintillation device 100 and photosensors 202, 204 coupled to the scintillation device. The photosensors 202, 204 can be electrically coupled to an electronics module. The scintillation device 100 can include the scintillation device described above.

The photosensors 202, 204 can receive the scintillating light or a derivative thereof, such as the wavelength shifted light, and generate an electronic signal, such as an electronic pulse, in response to the scintillating light or its derivative. The photosensors 202, 204 can be photomultiplier tubes (“PMTs”), semiconductor-based photomultipliers, or another suitable devices that generates an electronic pulse in response to the scintillating light. The electronic pulse from the photosensors 202, 204 can be transmitted to the electronics module 206.

The electronics module 206 can include one or more amplifiers, discriminators, analog-to-digital signal converters, photon counters, other electronic components, or any combination thereof. In certain embodiments, an electronics module can include at least a low-level discriminator, an upper-level discriminator, and a pulse shape discriminator. The electronics module 206 can be configured to detect particular radiation or detect more than one type of radiation. For example, the electronics module 206 can be configured to detect neutrons and discard pulses resulting from gamma rays or to detect both neutrons and gamma rays. Analysis may also incorporate one or more signal analysis algorithms in an application-specific integrated circuit (ASIC), an FPGA, or another similar device. For a neutron detector that is configured to detect neutrons, a counter can be incremented when a neutron is detected, and for a neutron detector that is configured to detect gamma rays, a different counter can be incremented when a gamma ray is detected.

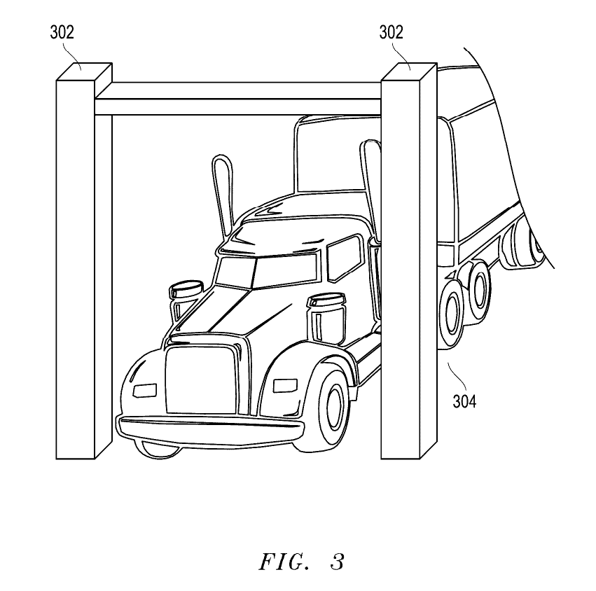

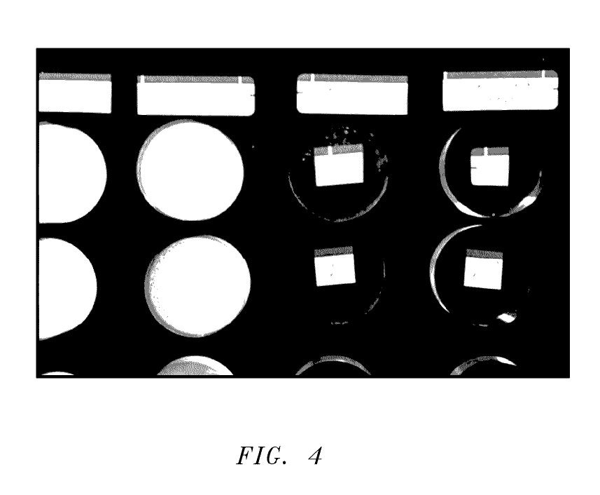

The radiation detection device 200 can be used for a variety of different applications. In a particular embodiment illustrated in FIG. 3, the radiation detection device can include a security inspection apparatus. The radiation detection device can be located within either or both of the vertical columns, the horizontal cross member, or any combination thereof.

When in use, an object can be placed near or pass through an opening within radiation detection device 302. As illustrated in FIG. 3, the object 304 is a vehicle, and in particular, a truck. The radiation detection device 302 can capture at least part of the targeted radiation emitted by the object (not illustrated) within the vehicle. The scintillation device can emit scintillating light or wavelength shifted light that is converted to an electronic signal by the photosensors. The electronic signal can be transmitted to an electronics module (not illustrated in FIG. 3) for further analysis.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### Embodiment 1

A scintillation device comprising:
a scintillator; and
a pliable moisture barrier encapsulating the scintillator.

### Embodiment 2

A scintillation device comprising:
a scintillator; and
a moisture barrier encapsulating the scintillator, the moisture barrier having a vapor transmission rate of no greater than 1.1×10−11 g/cm2/s.

### Embodiment 3

The device of any one of the preceding embodiments, wherein the moisture barrier includes a seal.

### Embodiment 4

The device of embodiment 3, wherein the seal has a width of at least 0.2 cm.

### Embodiment 5

The device of any one of the preceding embodiments, wherein the moisture barrier includes at least one water-resistant layer.

### Embodiment 6

The device of embodiment 5, wherein the water-resistant layer includes a metal.

### Embodiment 7

The device of embodiment 6, wherein the metal includes an atomic metal, a metal alloy, a metal oxide, or any combination thereof.

### Embodiment 8

The device of any one of embodiments 6 and 7, wherein the metal includes a metal having an atomic number of no greater than 34.

### Embodiment 9

The device of any one of embodiments 6 to 8, wherein the metal comprises an aluminum, a copper, a silver, a gold, or any combination thereof.

### Embodiment 10

The device of any one of embodiments 5 to 9, wherein the water-resistant layer includes a metal foil comprising the metal.

### Embodiment 11

The device of embodiment 10, wherein the metal foil comprises a continuous metal layer.

### Embodiment 12

The device of any one of the preceding embodiments, wherein the moisture barrier has a visible light transmission of no greater than 25%.

### Embodiment 13

The device of any one of the preceding embodiments, wherein the scintillator includes an inorganic scintillator material, an organic scintillator material, a non-scintillating high atomic number compound, or any combination thereof.

### Embodiment 14

The device of any one of the preceding embodiments, wherein the scintillator includes a plastic scintillator material.

### Embodiment 15

The device of embodiment 14, wherein the plastic scintillator material includes an organic scintillator material comprising 2,5-diphenyloxazole, 1,4-bis-2-(5-phenyloxazolyl)-benzene), terphenyl, 1,1,4,4-tetraphenylbutadiene, a tris complex of 2,6-pyridine dicarboxylic acid (dipicolinic acid, DPA), an Ir(mppy)3, an iridium-tris[2-(4-totyl)pyridinato-NC2], a pyrazolate-bridged cyclometalated platinum(II) complex, or any combination thereof.

### Embodiment 16

The device of embodiment 13, wherein the inorganic scintillator compound comprises a NaI, a CsI, a SrI2, a LiI, a LiF, a LaBr3, a LaCl3, a CeBr3, a Cs2LiLaBr6, a Cs2LiLaBr6-xClx, a Cs2LiLaBr6-xIx, a Cs2LiYCl6, a Cs2LiYCl6-xBrx, a CsSr2I5, a LiSr2I5, a BaF2, or any combination thereof.

### Embodiment 17

The device of embodiment 13, wherein the non-scintillating high atomic number compound includes a Bi, a Pb, an Jr, a Pt, an Au, or any combination thereof.

### Embodiment 18

The device of any one of the preceding embodiments, wherein the scintillator comprises a scintillator compound dispersed in a plastic matrix.

### Embodiment 19

The device of embodiment 18, wherein the plastic matrix includes a transparent polymer.

### Embodiment 20

The device of any one of embodiments 17 to 19, wherein the plastic matrix includes a transparent polymer comprising an epoxy, a polyvinyl toluene, a polystyrene, a polymethylmethacrylate, a polyvinylcarbazole, a polybutyrate, a polycarbonate, a polyurethane, a glycol modified polyethylene terphthalate, a polyethylene naphthalate, or any combination thereof.

### Embodiment 21

The device of any one of the preceding embodiments, wherein the moisture barrier further includes at least one polymer layer.

### Embodiment 22

The device of embodiment 21, wherein the at least one polymer layer includes at least two polymer layers, at least three polymer layers, or at least four polymer layers.

### Embodiment 23

The device of any one of embodiments 21 and 22, wherein at least one of the at least one polymer layers includes a thermoplastic polymer.

### Embodiment 24

The device of embodiment 23, wherein the thermoplastic polymer includes a polyethylene.

### Embodiment 25

The device of any one of embodiments 21 to 24, wherein the water-resistant layer is disposed between polymer layers.

### Embodiment 26

The device of any one of embodiments 21 to 25, wherein the moisture barrier includes at least two polymer layers on a first side of the water-resistant layer and at least two polymer layers on an opposite second side of the water-resistant layer.

### Embodiment 27

The device of embodiment 26, wherein the at least two polymer layers on the first side of the water-resistant layer include a first polymer layer comprising a first polymer and a second polymer layer comprising a second polymer that is different that the first polymer.

### Embodiment 28

The device of any one of embodiments 26 and 27, wherein each of the at least two polymer layers on the second side of the water-resistant layer include a third polymer layer comprising a third polymer and a fourth polymer layer comprising a fourth polymer that is different than the third polymer.

### Embodiment 29

The device of any one of embodiments 21 to 28, wherein at least one of the at least one polymer layers includes a polyester.

### Embodiment 30

The device of embodiment 29, wherein the polyester is a semi-aromatic polyester.

### Embodiment 31

The device of embodiment 30, wherein the semi-aromatic polyester includes a polyethylene terephthalate, a polybutylene terephthalate, a polytrimethylene terephthalate, a polyethylene naphthalate, or any combination thereof.

### Embodiment 32

The device of any one of embodiments 29 and 30, wherein the at least one layer polymer including a polyester forms an outermost layer of the moisture barrier.

### Embodiment 33

The device of any one of embodiments 1 to 21, wherein the moisture barrier includes a metal foil encapsulating the scintillator and coated with a polymer.

### Embodiment 34

The device of embodiment 33, wherein the polymer is an epoxy.

### Embodiment 35

The device of any one of embodiments 1 and 3 to 34, wherein the moisture barrier has a vapor transmission rate of no greater than 1.1×10−11 g/cm2/s, as measured according to ASTM E 96.

### Embodiment 36

The device of any one of the preceding embodiments, wherein the an interior of the moisture barrier has a water gain of no greater than 0.005%, no greater than 0.004%, or no greater than 0.003%, based on a total volume of the interior of the moisture barrier, measured at room temperature following an exterior of the moisture barrier being exposed to a 55° C. environment at 80% humidity for 400 hours.

### Embodiment 37

The device of any one of the preceding embodiments, wherein the scintillator has a visible light transmission of at least 70%, measured after an exterior of the moisture barrier is exposed to a 55° C. environment at 80% humidity for 400 hours.

### Embodiment 38

The device of any one of the preceding embodiments, wherein the scintillator retains at least 90% of gamma ray sensitivity after an exterior of the moisture barrier is exposed to a 55° C. environment at 80% humidity for 400 hours at and then a −40° C. environment at 80% humidity for 36 hours.

### Embodiment 39

The device of any one of the preceding embodiments, wherein the scintillation device further comprises a desiccant.

### Embodiment 40

The device of embodiment 39, wherein the desiccant is located within the moisture barrier.

### Embodiment 41

The device of any one of the preceding embodiments, wherein the scintillator has a length of at least 1 meter, at least 1.2 meters, at least 1.4 meters, at least 1.6 meters, at least 1.8 meters, or at least 2 meters.

### Embodiment 42

The device of any one of the preceding embodiments, wherein the scintillator has a volume of at least 0.25 m³, at least 0.27 m³, or even at least 0.29 m³.

### Embodiment 43

The device of any one of the preceding embodiments, wherein the scintillator has gamma ray sensitivity.

### Embodiment 44

The device of any one of the preceding embodiments, wherein the scintillator has neutron sensitivity.

### Embodiment 45

The device of any one of the preceding embodiments, wherein the moisture barrier completely surrounds the scintillator.

### Embodiment 46

The device of any one of the preceding embodiments, further comprising a grounding wire coupled to the moisture barrier.

### Embodiment 47

The device of any one of the preceding embodiments, wherein the scintillator retains at least 80%, or at least 85%, or at least 90% of gamma ray sensitivity after an exterior of the moisture barrier is exposed to a 55° C. environment at 85% humidity for 1500 hours; wherein the scintillator retains at most 100%, or at most 99%, or at most 97% of gamma ray sensitivity after an exterior of the moisture barrier is exposed to a 55° C. environment at 85% humidity for 1500 hours.

### Embodiment 48

The device of any one of the preceding embodiments, wherein, after 1500 hours at 55° C. and 85% humidity, the device exhibits a change in detectability of gamma rays at −30° C. of no greater than 5%, or no greater than 3%, or no greater than 1%; wherein, after 1500 hours at 55° C. and 85% humidity, the device exhibits a change in detectability of gamma rays at −30° C. of at least 0%, or at least 0.01%, or at least 0.05%.

### Embodiment 49

The device of any one of the preceding embodiments, wherein, after 1500 hours at 55° C. and 85% humidity, the device exhibits a change in gamma ray pulse height ratio of no greater than 5%, or no greater than 3%, or no greater than 1%; wherein, after 1500 hours at 55° C. and 85% humidity, the device exhibits a change in gamma ray pulse height ratio of at least 0%, or at least 0.01%, or at least 0.05%.

### Embodiment 50

A detection device comprising a photosensor coupled to the scintillation device of any one of the preceding embodiments.

### Embodiment 51

A security inspection apparatus comprising the scintillation device or detection device of any one of the preceding embodiments.

### Embodiment 52

The security inspection device of embodiment 51, wherein the security inspection device is a port-of-entry detector.

### Embodiment 53

The device or apparatus of any one of the preceding embodiments, wherein the moisture barrier further comprises an oxygen getter.

### EXAMPLES

### Example 1

Samples were prepared and tested using examples of the scintillation device described herein and comparative examples.

The examples of the scintillation device described herein were prepared by placing PVT scintillators in moisture barriers including a laminate and sealed the laminates to encapsulate the scintillators. The structure of the laminates were: exterior/polyethylene terephthalate/polyethylene/aluminum foil/polyethylene/linear low density polyethylene/interior.

The comparative examples were prepared by wrapping PVT scintillator samples in aluminum foil and taping the seams.

The samples were then heated to 50° C. in 80% relative humidity and then brought to room temperature. FIG. 4 includes a photograph of the resulting scintillators from the comparative examples (left) and the examples of the scintillation device described herein (right). As shown in the photograph of FIG. 4, the examples of the scintillation device described herein resulted in maintaining a transparent scintillator, whereas the comparative examples resulted in the previously transparent scintillator exhibiting significant haze. Thus, the example indicates that the examples of the scintillation device described herein were able to significantly reduce the penetration of water vapor through the moisture barrier.

### Example 2

Two detectors, Samples 1 and 2, were made and tested as discussed below. Sample 1 was made of plastic scintillator (PVT, commercial name: Saint-Gobain BC-408). The scintillator was a cuboid with dimensions 2 in (5 cm)×4 in (10 cm)×16 in (40.6 cm). Five of the cuboid faces were covered with a PTFE sheet, aluminum foil, and an additional moisture barrier film. The moisture barrier film was a 0.0036″ thick, heat sealable, polymer-aluminum film laminate comprised of one layer of polyethylene terephthalate, three layers of polyethylene, and one layer of aluminum film. The remaining 2×4 in.² face was covered by an aluminum plate with a through-hole in the center. The aluminum plate was hermetically sealed against the plastic using an elastomer gasket. A photomultiplier tube (PMT) was placed in the through-hole sealed to the plastic and aluminum plate with epoxy. The moisture barrier film was sealed against the aluminum plate with a gasket. The moisture barrier film was 0.0036 in. (0.009144 cm) thick and had a measured moisture vapor transmission rate (MVTR) of 1.1E-11 g/cm²/s. The seal width was 0.5 cm.

Sample 2 was made identical to Sample 1 except that Sample 2 did not include the moisture barrier film. That is, Sample 2 was covered with a PTFE sheet and a wrap of aluminum foil, but the moisture barrier was not included.

Samples 1 and 2 were tested in an environmental chamber set at 55° C. and 85% relative humidity (RH) for 1452 hours. The detectability of a ⁵⁷Co isotopic gamma ray source was measured at −30° C. before and after the environmental chamber test. As used in this example, the term “detectability” refers to the ratio of gamma ray count rate to the square root of background count rate. At a temperature of −30° C., absorbed water vapor, if present, would condense, create a haze in the plastic, and reduce detectability. The detectability of Samples 1 and 2, before and after the application of heat and humidity, is provided below in Table 1.

TABLE 1
Detectability at −30° C.

| | Before environmental | After 1452 hrs. at |
|---|---|---|
| Configuration | chamber test | 55° C. and 85% RH |
| Sample 1 | 13.4 \sqrt{count/s} | 13.4 \sqrt{count/s} |
| Sample 2 | 16.7 \sqrt{count/s} | 11.9 \sqrt{count/s} |

The data in Table 1 show that Sample 2 exhibited a reduction in detectability, whereas Sample 1 showed no reduction in detectability. The data indicate that detector performance degradation at −30° C. can be reduced or eliminated through use of the moisture barrier film.

The pulse height (PH) of Samples 1 and 2 were also measured. The pulse height is the integrated signal from the PMT and is proportional to the amount of scintillation light collected by the PMT. A ¹³⁷Cs isotopic gamma ray source was placed at a near position and at a far position from the PMT. The near position was 2 in. (5 cm) from the PMT and the far position was 14 in. (35.5 cm) from the PMT. Absorbed and condensed water vapor, if present, would attenuate scintillation light resulting in a decrease in the PH at the far position as compared to the near position. Table 2 below includes the ratio

[PH at near position]/[PH at far position] for each sample taken at room temperature (22° C.) before and after the environmental chamber test.

TABLE 2
$Pulse Height Ratio \text{:} \frac{PH at far position}{PH at near position} at 22 ° C .$

| | Before environmental chamber | After 1452 hrs. at 55° C. and |
|---|---|---|
| Configuration | test | 85% RH |
| Sample 1 | 0.97 | 0.96 |
| Sample 2 | 0.92 | 0.75 |

The PH ratio for Sample 2 showed a reduction of about 0.17, whereas the PH ratio for Sample 1 showed minimal reduction. The data indicates that, without the moisture barrier film, light generated far from the PMT will be degraded after many hundreds of hours at high temperature and high humidity, while virtually no degradation occurs when sealed within the moisture barrier film.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A scintillation device comprising:
a scintillator; and
a pliable moisture barrier encapsulating the scintillator.

2. The scintillation device of claim 1, wherein the moisture barrier has a vapor transmission rate of no greater than 1.1×10⁻¹¹ g/cm²/s.

3. The device of claim 2, wherein the moisture barrier includes a seal having a width of at least 0.2 cm.

4. The device of claim 1, wherein the moisture barrier includes at least one water-resistant layer.

5. The device of claim 4, wherein the water-resistant layer includes a metal comprising an atomic metal, a metal alloy, a metal oxide, or any combination thereof.

6. The device of claim 5, wherein the water-resistant layer includes a metal foil comprising the metal.

7. The device of claim 1, wherein the scintillator comprises a scintillator compound dispersed in a plastic matrix.

8. The device of claim 7, wherein the plastic matrix includes a transparent polymer.

9. The device of claim 6, wherein the water-resistant layer is disposed between polymer layers.

10. The device of claim 1, wherein the moisture barrier includes at least two polymer layers on a first side of the water-resistant layer and at least two polymer layers on an opposite second side of the water-resistant layer.

11. The device of claim 1, wherein the an interior of the moisture barrier has a water gain of no greater than 0.005%, based on a total volume of the interior of the moisture barrier, measured at room temperature following an exterior of the moisture barrier being exposed to a 55° C. environment at 80% humidity for 400 hours.

12. The device of claim 1, wherein the scintillator has a visible light transmission of at least 70%, measured after an exterior of the moisture barrier is exposed to a 55° C. environment at 80% humidity for 400 hours.

13. The device of claim 1, wherein the scintillator retains at least 90% of gamma ray sensitivity after an exterior of the moisture barrier is exposed to a 55° C. environment at 80% humidity for 400 hours at and then a −40° C. environment at 80% humidity for 36 hours.

14. The device of claim 1, wherein the scintillator has a length of at least 1 meter.

15. The device of claim 1, wherein the moisture barrier further comprises an oxygen getter.

16. The device of claim 1, wherein the scintillator retains at least 80% of gamma ray sensitivity after an exterior of the moisture barrier is exposed to a 55° C. environment at 85% humidity for 1500 hours.

17. The device of claim 1, wherein, after 1500 hours at 55° C. and 85% humidity, the device exhibits a change in detectability of gamma rays at −30° C. of no greater than 5%.

18. The device of claim 1, wherein, after 1500 hours at 55° C. and 85% humidity, the device exhibits a change in gamma ray pulse height ratio of no greater than 5%.

19. A detection device comprising:
a photosensor; and
a scintillation device coupled to the photosensor, the scintillation device comprising:
a scintillator; and
a moisture barrier encapsulating the scintillator, the moisture barrier having a vapor transmission rate of no greater than 1.1×10⁻¹¹ g/cm²/s.

20. The detection device of claim 19, wherein the moisture barrier is pliable.
